(19) United States
(12) Patent Application Publication
(10) Pub. No.: US 2019/0376552 A1
(43) Pub. Date: Dec. 12, 2019

(54) MULTIPLE PIECE BUSHING ASSEMBLY

(71) Applicant: Designatronics Incorporated, Hicksville, NY (US)

(72) Inventors: David Ladyzhensky, Brooklyn, NY (US); Robert Kufner, Erie, PA (US)

(21) Appl. No.: 16/406,718

(22) Filed: May 8, 2019

Related U.S. Application Data
(60) Provisional application No. 62/682,072, filed on Jun. 7, 2018.

(51) Int. Cl. F16C 17/10; F16C 35/02; F16H 57/00

(52) U.S. Cl. CPC F16C 17/10; F16C 35/02; F16C 2361/61; F16H 57/0031; F16H 57/0025

(57) ABSTRACT

An improved bushing assembly comprising an inner bushing having an outwardly-facing frusto-conical surface, an outwardly-facing threaded surface, and an inwardly-facing cylindrical surface adapted to engage a shaft, an outer bushing having first and second bushing bearing surfaces and an inwardly-facing frusto-conical surface in sliding engagement with the outwardly-facing frusto-conical surface of the inner bushing, a nut having an inwardly-facing threaded surface in mating engagement with the outwardly-facing threaded surface of the inner bushing and first and second nut bearing surfaces radially overlapping the first and second bushing bearing surfaces of the outer bushing, whereby rotation of the nut in first and second rotational directions relative to the inner bushing moves the outer bushing in first and second axially directions to operatively tighten or untighten, respectively, the inner bushing around the shaft.

### TECHNICAL FIELD

The present invention relates to bushings, and more particularly to a bushing that is adapted to selectively engage and disengage with a shaft.

### BACKGROUND ART

U.S. Pat. No. 3,501,183 is directed to a linear self-locking wedge device that relates the coefficient of starting friction on the straight surface of a member to the frictional angle of an inclined wedge surface. U.S. Pat. No. 4,699,388 is directed to a self-centering collet for high precision. U.S. Pat. No. 4,817,972 is directed to a collet chuck for mounting a tool to a rotary spindle in various kinds of machine tools. U.S. Pat. No. 5,855,462 is directed to a cone bolt-connection for multi-disc shaft clutches having multiple clamping sleeves. U.S. Pat. No. 6,883,407 is directed to an expanding collet assembly for a pick-off spindle.

### BRIEF SUMMARY

With parenthetical reference to corresponding parts, portions or surfaces of the disclosed embodiment, merely for the purposes of illustration and not by way of limitation, an improved bushing assembly (9) is provided comprising: an inner bushing (15) orientated about a longitudinal axis (x-x); the inner bushing (15) having an outwardly-facing frusto-conical surface (31), an outwardly-facing threaded surface (33), and an inwardly-facing cylindrical surface (35) adapted to engage a shaft (10); an outer bushing (14) orientated about the longitudinal axis; the outer bushing (14) having a first bushing bearing surface (25) orientated in a plane transverse to the longitudinal axis, a second bushing bearing surface (22) orientated in a plane transverse to the longitudinal axis, and an inwardly-facing frusto-conical surface (26) in sliding engagement with the outwardly-facing frusto-conical surface (31) of the inner bushing (15); a nut (13) orientated about the longitudinal axis; the nut having an inwardly-facing threaded surface (43) in mating engagement with the outwardly-facing threaded surface (33) of the inner bushing (15); the nut having a first nut bearing surface (44) orientated in a plane transverse to the longitudinal axis and radially overlapping the first bushing bearing surface (25) of the outer bushing (14); and the nut having a second nut bearing surface (46) orientated in a plane transverse to the longitudinal axis and radially overlapping the second bushing bearing surface (22) of the outer bushing (14); whereby rotation of the nut (13) about the longitudinal axis in a first rotational direction relative to the inner bushing (15) moves the outer bushing (14) in a first axially direction relative to the inner bushing (15) to operatively tighten the inner bushing (15) around the shaft (10), and rotation of the nut (13) about the longitudinal axis in a second rotational direction relative to the inner bushing (15) moves the outer bushing (14) in a second axially direction relative to the inner bushing (15) to operatively untighten the inner bushing (15) around the shaft (10).

The nut (13) may comprise an annular groove (50) having a first annular side surface (44) and a second annular side surface (46); the outer bushing (14) may comprise an annular flange (28) having a first annular side surface (25) and a second annular side surface (22); the annular flange (28) of the outer bushing (14) may be received in the annular groove (50) of the nut (13); and the first annular side surface (44) of the annular groove (50) may comprise the first nut bearing surface, the second annular side surface (46) of the annular groove (50) may comprise the second nut bearing surface, the first annular side surface (25) of the annular flange (28) may comprise the first bushing bearing surface, and the second annular side surface (22) of the annular flange (28) may comprise the second bushing bearing surface.

The outer bushing (14) may comprise an outwardly-facing surface comprising a plurality of circumferentially spaced axially extending gear teeth (60). The inwardly-facing frusto-conical surface (26) of the outer bushing (14) and the opposed outwardly-facing frusto-conical surface (31) of the inner bushing (15) may each have a coefficient of friction less than the inwardly-facing cylindrical surface (35) of the inner bushing (15). The first nut bearing surface may comprise an annular face (44) of the nut (13), the first bushing bearing surface may comprise an annular end face (25) of the outer bushing (14), the second nut bearing surface may comprise an annular flange (49) of the nut (13), and the second bushing bearing surface may comprise an annular shoulder (28) of the outer bushing (14).

### BRIEF DESCRIPTION OF THE DRAWINGS

FIG. 1 is a left perspective view of a first embodiment of an improved bushing assembly engaging a shaft.

FIG. 2 is longitudinal vertical sectional view of the assembly shown in FIG. 1 in a tightening orientation.

FIG. 3 is longitudinal vertical sectional view of the assembly shown in FIG. 1 in a loosening orientation.

FIG. 4 is a perspective view of the outer bushing shown in FIG. 2.

FIG. 5 is a left side elevational view of the outer bushing shown in FIG. 4.

FIG. 6 is a longitudinal vertical sectional view of the outer bushing shown in FIG. 5, taken generally on line C-C of FIG. 5.

FIG. 7 is a perspective view of the inner bushing shown in FIG. 2.

FIG. 8 is a left side elevational view of the inner bushing shown in FIG. 7.

FIG. 9 is a longitudinal vertical sectional view of the inner bushing shown in FIG. 8, taken generally on line C-C of FIG. 8.

FIG. 10 is a perspective view of the nut shown in FIG. 2.

FIG. 11 is a left side elevational view of the nut shown in FIG. 10.

FIG. 12 is a longitudinal vertical sectional view of the nut shown in FIG. 11, taken generally on line C-C of FIG. 11.

### DETAILED DESCRIPTION OF THE EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., crosshatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

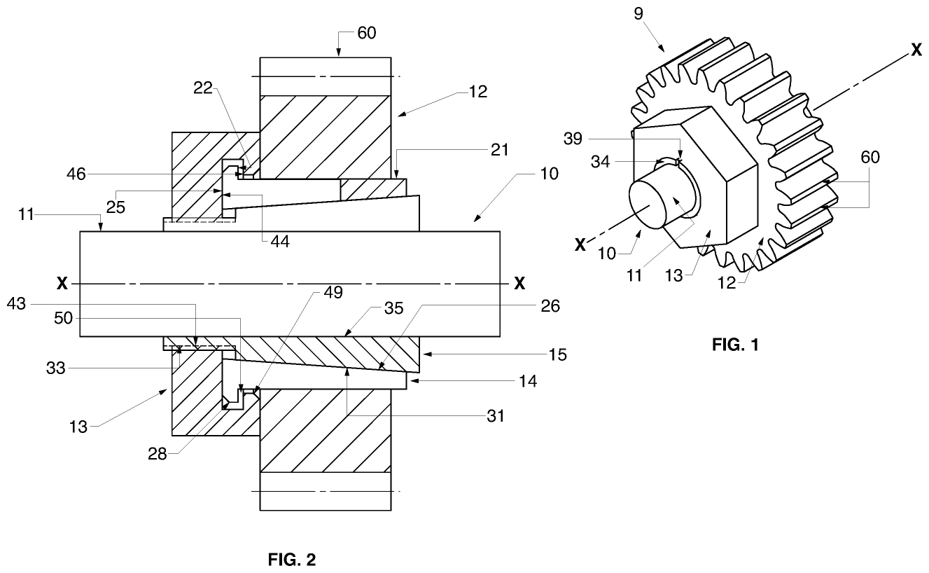

Referring now to FIGS. 1-3, an improved bushing assembly is provided, a first embodiment of which is generally indicated at 9. As shown, assembly 9 is adapted to lock onto shaft 10. Assembly 9 generally comprises nut 13, outer bushing 14, and inner bushing 15.

With reference to FIG. 6, outer bushing 14 is a specially configured cylindrical member elongated along axis x-x and is generally bounded by rightwardly-facing vertical annular surface 20, outwardly-facing horizontal cylindrical surface 21, rightwardly-facing annular vertical surface 22, outwardly-facing horizontal cylindrical surface 23, leftwardly and outwardly-facing frusto-conical surface 24, leftwardly-facing vertical annular surface 25, and rightwardly and inwardly-facing frusto-conical surface 26. As shown, four circumferentially spaced longitudinally extending slots, severally indicated at 29, are provided in outer bushing 14. Surfaces 22, 23, 24, and the outer annular portion of surface 25 generally define outwardly extending annular flange 28.

With reference to FIG. 9, inner bushing 15 is a specially configured cylindrical member elongated along axis x-x and is generally bounded by rightwardly-facing vertical annular surface 30, leftwardly and outwardly-facing frusto-conical surface 31, leftwardly-facing annular vertical surface 32, outwardly-facing horizontal cylindrical threaded surface 33, leftwardly-facing vertical annular surface 34, and inwardly-facing horizontal cylindrical surface 35. As shown, circumferentially spaced longitudinally extending slot 39 is provided in inner bushing 15.

With reference to FIG. 12, nut 13 is a specially configured cylindrical member elongated along axis x-x and is generally bounded by rightwardly-facing vertical hexagonal and annular surface 40, outwardly-facing horizontal hexagonal surface 41, leftwardly-facing hexagonal and annular vertical surface 42, inwardly-facing horizontal cylindrical threaded surface 43, rightwardly-facing vertical annular surface 44, inwardly-facing horizontal cylindrical surface 45, leftwardly-facing vertical annular surface 46, inwardly-facing horizontal cylindrical surface 47, and rightwardly and inwardly-facing frusto-conical surface 48. Surfaces 46, 47, 48, and the inner annular portion of surface 40 generally define inwardly extending annular flange 49. Surfaces 46, 45, and the outer annular portion of surface 44 generally define inwardly-facing annular groove 50.

Outer bushing 14 in sliding engagement with inner bushing 15 along opposed frusto-conical surfaces 31 and 26, respectively. Nut 13 is in threaded engagement with inner bushing 15 at the opposed mated threads of outer cylindrical threaded surface 33 of inner bushing 15 and inner cylindrical threaded surface 43 of nut 13. Nut 13 and inner bushing 15 are also in axial bearing engagement, with outwardly extending flange 28 of outer bushing 14 received in and radially overlapping opposed inwardly facing groove 50 of nut 13. Nut 13 is selectively rotatable about axis x-x relative to inner bushing 15, on which nut 13 is concentrically supported, and outer bushing 14.

Inner cylindrical surface 35 of inner bushing 15 engages outer cylindrical surface 11 of shaft 10. As nut 13 is tightened or rotated clockwise about axis x-x on inner bushing 15, as shown in FIG. 2, right annular face 44 of nut 13 bears against left annular face 25 of outer bushing 14, which in turn presses inwardly facing frusto-conical surface 26 of outer bushing 14 against opposed outer frusto-conical surface 31 of inner bushing 15, which in turn presses inner cylindrical surface 35 of inner bushing 15 against outer cylindrical surface 11 of shaft 10, thereby tightening and locking assembly 9 against shaft 10 by frictional contact. Outer geared wheel 12 with gear teeth 60 is fixed to outer surface 21 of outer bushing 14 and is thereby frictionally locked to shaft 10 via assembly 9. However, any other element or mechanical structure that is desired to be locked to shaft 10 may be used as alternatives to outer gear 12.

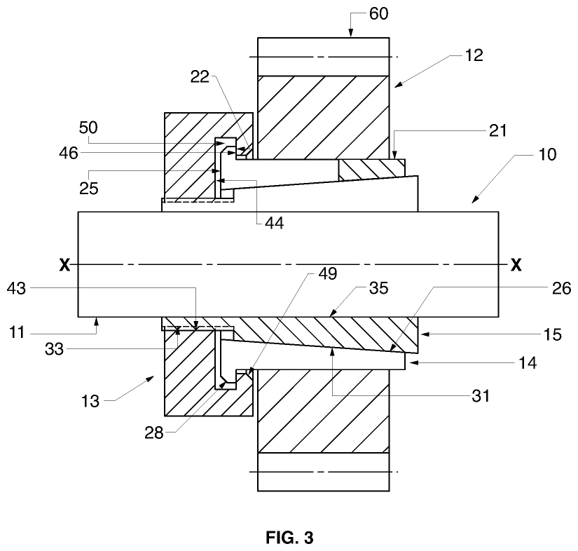

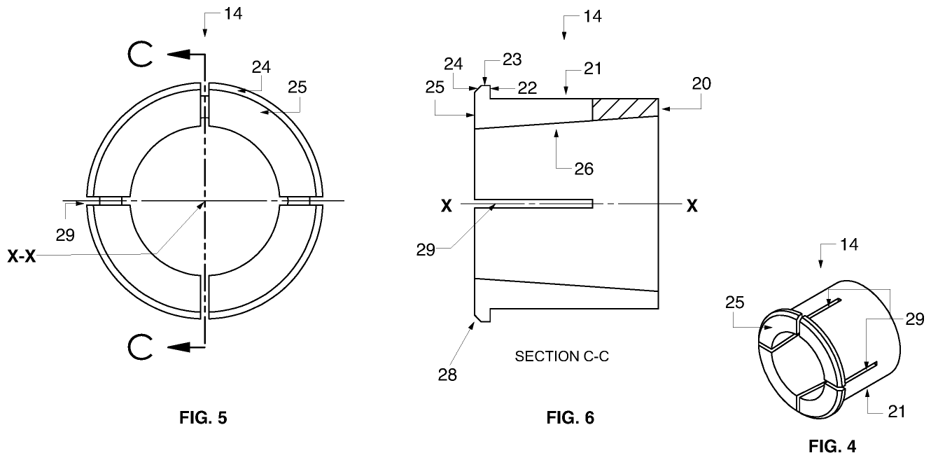

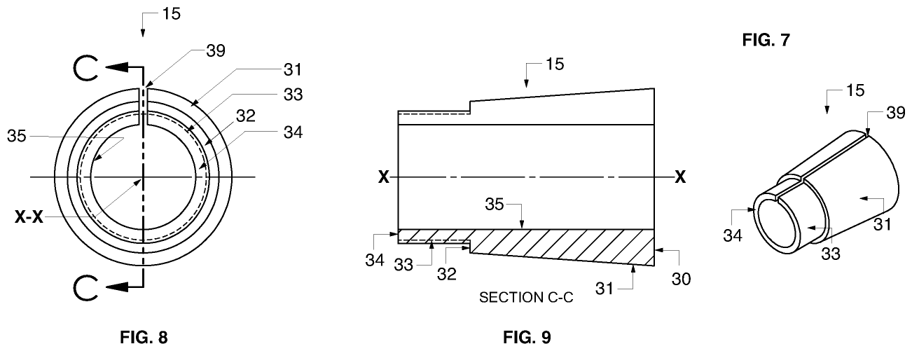

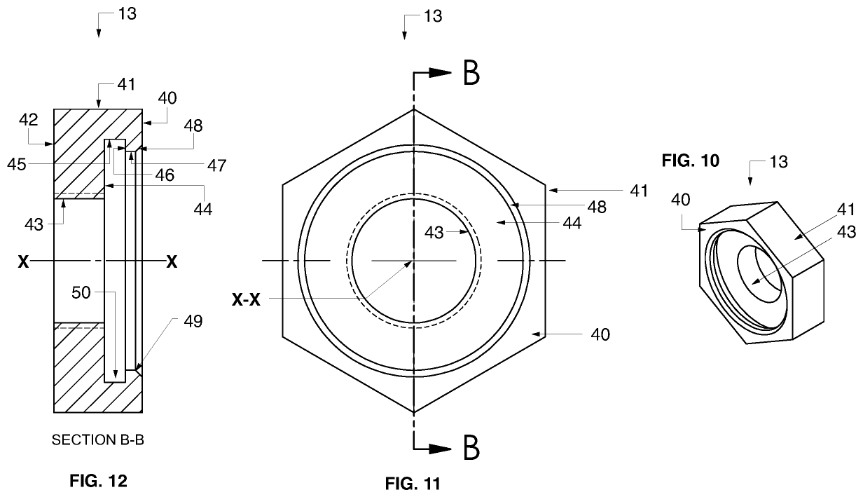

Assembly 9 also provides an unlocking mechanism. When nut 13 is loosened or rotated counter-clockwise about axis x-x on inner bushing 15, as shown in FIG. 3, left annular side 46 of groove 50 in nut 13 bears against right annular side 22 of flange 28 of outer bushing 14, which pulls outer bushing 14 to the left, and such rotation, through threaded mating surfaces 33 and 43, pushes inner bushing 15 to the right, thereby releasing the engagement of opposed frusto-conical surfaces 31 and 26 of inner bushing 15 and outer bushing 14, respectively, and releasing the force applied to inner cylindrical surface 35 of inner bushing 15 against outer cylindrical surface 11 of shaft 10, thereby loosening and unlocking assembly 9 from shaft 10.

The present invention contemplates that many changes and modifications may be made. Therefore, while forms of the improved bushing assembly have been shown and described, and a number of alternatives discussed, persons skilled in this art will readily appreciate that various additional changes and modifications may be made without departing from the scope of the invention, as defined and differentiated by the following claims.

What is claimed is:

1. A bushing assembly comprising:
an inner bushing orientated about a longitudinal axis;
said inner bushing having an outwardly-facing frusto-conical surface, an outwardly-facing threaded surface, and an inwardly-facing cylindrical surface adapted to engage a shaft;
an outer bushing orientated about said longitudinal axis;
said outer bushing having a first bushing bearing surface orientated in a plane transverse to said longitudinal axis, a second bushing bearing surface orientated in a plane transverse to said longitudinal axis, and an inwardly-facing frusto-conical surface in sliding engagement with said outwardly-facing frusto-conical surface of said inner bushing;
a nut orientated about said longitudinal axis;
said nut having an inwardly-facing threaded surface in mating engagement with said outwardly-facing threaded surface of said inner bushing;
said nut having a first nut bearing surface orientated in a plane transverse to said longitudinal axis and radially overlapping said first bushing bearing surface of said outer bushing; and
said nut having a second nut bearing surface orientated in a plane transverse to said longitudinal axis and radially overlapping said second bushing bearing surface of said outer bushing;
whereby rotation of said nut about said longitudinal axis in a first rotational direction relative to said inner bushing moves said outer bushing in a first axially direction relative to said inner bushing to operatively tighten said inner bushing around said shaft, and rotation of said nut about said longitudinal axis in a second rotational direction relative to said inner bushing moves said outer bushing in a second axially direction relative to said inner bushing to operatively untighten said inner bushing around said shaft.

2. The bushing assembly of claim 1, wherein:
said nut comprises an annular groove having a first annular side surface and a second annular side surface;
said outer bushing comprises an annular flange having a first annular side surface and a second annular side surface;
said annular flange of said outer bushing is received in said annular groove of said nut; and
said first annular side surface of said annular groove comprises said first nut bearing surface, said second annular side surface of said annular groove comprises said second nut bearing surface, said first annular side surface of said annular flange comprises said first bushing bearing surface, and said second annular side surface of said annular flange comprises said second bushing bearing surface.

3. The bushing assembly of claim 1, wherein said outer bushing comprises an outwardly-facing surface comprising a plurality of circumferentially spaced axially extending gear teeth.

4. The bushing assembly of claim 1, wherein said inwardly-facing frusto-conical surface of said outer bushing and said opposed outwardly-facing frusto-conical surface of said inner bushing each have a coefficient of friction less than said inwardly-facing cylindrical surface of said inner bushing.

5. The bushing assembly of claim 1, wherein said first nut bearing surface comprises an annular face of said nut, said first bushing bearing surface comprises an annular end face of said outer bushing, said second nut bearing surface comprises an annular flange of said nut, and said second bushing bearing surface comprises an annular shoulder of said outer bushing.
